(19) United States
(12) Patent Application Publication
(10) Pub. No.: US 2008/0092407 A1
(43) Pub. Date: Apr. 24, 2008

(54) Type of Nail that is Attached to a Metal Piece

(76) Inventor: David Pedro Ramirez, Pahrump, NV (US)

Correspondence Address: David Pedro Ramirez, 4291 BELL VISTA AV, PAHRUMP, NV, 89060, US

(21) Appl. No.: 11/876,474

(22) Filed: Oct. 22, 2007

Related U.S. Application Data
(60) Provisional application No. 60/862,512, filed on Oct. 23, 2006.

(51) Int. Cl. A43C 19/00; F16B 15/00; F16B 15/02

(52) U.S. Cl. 36/70 R; 411/484; 411/487; 411/493

(57) ABSTRACT

My invention is to prevent pants from dragging due to excessive length and prevents a person from stepping or tripping over pants. It also prevents the pants from shredding. A pants guard, for attachment to a shoe, having a head with an insertion shaft inner portion and a T outer portion. The nail is attached to the back portion of a shoe, with the head remaining on the outside of the shoe just above the shoe heel. A pants hem is held behind the nail head and keeps the hem above the shoe heel.

### PRIOR APPLICATION

This application emanates from a prior Provisional patent application filed Oct. 23, 2006, Ser. No. 60862512.

### FIELD OF THE INVENTION

The present invention relates to clothing accessories, and more particularly to a type of nail that is attached to a metal piece that functions to protect the cuffs of unaltered or baggy-style pants from being dragged along the ground and stepped on, and also serving as an fashionable adornment for the wearer of the pants.

### BACKGROUND OF THE INVENTION

The invention relates to a type of nail that is attached to a metal piece. In particular, the invention is a guard that is attached to the back of a shoe and holds a pants hem in place, above the heel of the shoe.

The present fashion styles include pants that have a longer length. In particular, extra baggy, long pants have become stylish. When walking while wearing this type of pants, it is common for the hem or cuff of the pants to get caught under the heel of a person's shoe. Besides causing the pants to get dirty from dragging on the ground, it is also possible for the hem of the pants to be ripped. Once ripped, it is often necessary to discard the garment.

Thus, there exists a need for a guard that serves to protect the hems of a pair of pants having a longer length than the average pants. Such a guard may be attached to the back of a pair of shoes and then used to hold the hem in place. While this type of device may prevent the hem from falling under a wearer's shoe, it is important that the front of the pants are allowed to drape in a natural fashion.

While these units may be suitable for the particular purpose employed, or for general use, they would not be as suitable for the purposes of the present invention as disclosed hereafter.

When people wear pants that have not been properly altered in length or pants made in today's baggy style, the cuffs of the pants sometimes extend below the heels of the wearers shoes where they are drag along the ground and stepped on during walking. This causes the cuffs of the pants to become excessively dirty, stained and prematurely worn out from abrasion against the ground.

Clip-like devices for holding the cuffs of pants and shirtsleeves have been invented in the past. U.S. Pat. No. 898,503 issued Sep. 15, 1908 to Plummer, U.S. Pat. No. 1,782,057 issued Nov. 18, 1930 to Bollinger and U.S. Pat. No. 6,618,862 B1 issued Sep. 16, 2003 to Bunjes are examples of the cuff holding devices of the past. These devices, although suitable for their intended purposes, fail to provide a secure attachment to the shoes and pant cuffs, while also serving as a fashionable adornment for the wearer of the baggy pants like the present invention as will become evident from the following disclosure.

None of the above inventions and patents, taken either singly or in combination, is seen to describe the instant invention as claimed. Thus a cuff clip jewelry device solving the aforementioned problems is desired.

### SUMMARY OF THE INVENTION

In view of the foregoing disadvantages inherent in the prior art, the present invention provides a type of nail that is attached to a metal piece for attachment to a shoe. As such, the general purpose of the present invention, which will be described subsequently in greater detail, is to provide a new and improved pants hem guard which has all the advantages of the prior art and none of the disadvantages.

To attain this, the present invention essentially comprises a type of nail that is attached to a metal piece, for attachment to a shoe.

It is an object of the invention to produce a type of nail that is attached to a metal piece that protects the bottom of a pair of pants from damage. Accordingly, the type of nail that is attached to a metal piece is designed to fit within any pair of shoes having a back portion and serves to hold the hem of the pants in place above the shoe heel.

It is a further object of the invention to produce a type of nail that is attached to a metal piece that is inconspicuous and does not interrupt with the natural drape of the pants. Accordingly, the nail is barely visible when in place, with only the clip insert extending over the pants hem. Further, since the nail only holds the back portion of the pants hem, the remainder of the hem is interrupted.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims. piece.

### BRIEF DESCRIPTION OF THE DRAWINGS

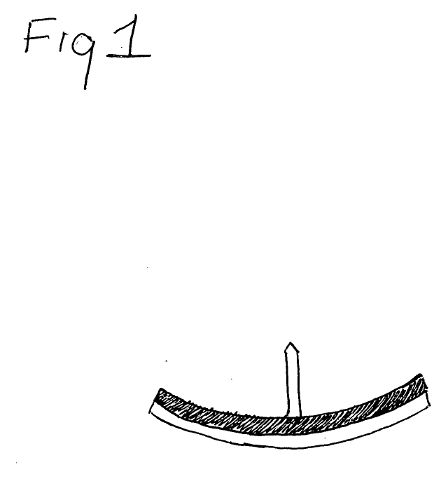

The present invention relates to a type of nail that is attached to a metal piece FIG. 1.

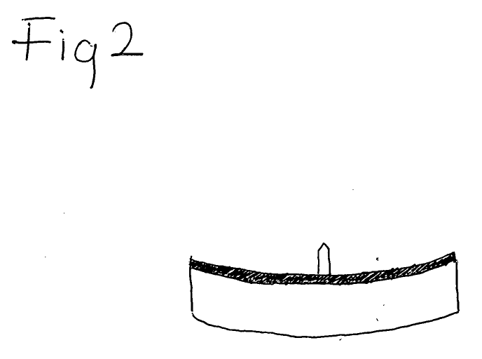

First there is a bar which looks like a bar on a bracelet (the kind with your name on it) and is attached to a type of nail FIG. 2. The bar works so you fingers don't have to push or press against a small nail. Then the nail works through the bottom of the pants at the seam as if you were nailing your pants against your shoe, into the sole itself.

The bar is attached to the type of nail which creates a device making it easy to push in through your pants into the sole of your shoe. It is used to make your pants not drag.

Instead of a straight bar I was thinking of coating it with plastic, rubber or make the bar round, square a triangle or other shapes to make it look different but would serve the same purpose.

While I have shown and described only two embodiments in accordance with the present invention, it is understood that the same is not limited thereto but is susceptible of numerous changes and modifications as known to those skilled in the art, and I therefore do not wish to be limited to the details shown and described herein, but intend to cover all such changes and modifications as are encompassed by the scope of the appended claims.

### DETAILED DESCRIPTION OF AN ENABLING AND PREFERRED EMBODIMENT

The illustrations and examples provided herein are for explanatory purposes and are not intended to limit the scope of the appended claims, as those skilled in the art will make modifications to the invention for particular uses.

What is claimed is:

1. A nail that is attached to a metal piece having a slightly curved or arched flat head on top and a shaft attached to the head with a sharp point at the opposing end of the shaft.

2. The device of claim 1 wherein, the nail that is attached to a metal piece is placed in the rear portion of the shoe as to hold the pant leg from dragging the ground.

3. The device of claim 1 wherein, the nail that is attached to a metal piece has a curved head to match the rear most radius of the shoe to be attached.

4. The device of claim 1 wherein, the nail that is attached to a metal piece has a contoured shaft as not be tubular in shape or design.
